(19) United States
(12) Patent Application Publication
(10) Pub. No.: US 2012/0005287 A1
(43) Pub. Date: Jan. 5, 2012

(54) DEVICE, SYSTEM AND METHOD FOR CREATING AND TRANSMITTING MULTIMEDIA MESSAGES

(75) Inventors: Isser Gadel, Herzelia B (IL); Rami Reshef, Ramat Hasharon (IL)

(73) Assignee: LANDA VENTURES LTD, NES ZIONA (IL)

(21) Appl. No.: 13/129,400

(22) PCT Filed: Nov. 15, 2009
(86) PCT No.: PCT/IL09/01073

§ 371 Date: Jun. 20, 2011

(30) Foreign Application Priority Data
Nov. 16, 2008 (IL) 195323

(51) Int. Cl. G06F 15/16

(52) U.S. Cl. 709/206

(57) ABSTRACT

The present invention relates to a system and method for creating and sending, by means of a telecommunications device, such as a cellular telephone, unique, dynamically personalized multimedia messages to a remote recipient. The method includes generating, capturing, selecting, recording, and assembling media-type content inputs such as video, audio, voice, text or graphic, by means of the telecommunications device. The method further includes creating and storing an instruction file. The instructions file includes addresses of at least one media-type content input stored on a remote server device and/or data from the computing device, which, when assembled in the remote server device, create the multimedia message.

### FIELD OF THE INVENTION

The present invention relates to a multimedia message system in general and, in particular, to a system and method for creating and sending unique, dynamically personalized multimedia messages to a remote recipient.

### BACKGROUND OF THE INVENTION

Multimedia is a general term used to describe any application or technology that can be used to manipulate text, audio, images, graphics, and video. Multimedia typically includes one of the following: a) text and sound; b) text, sound, and still or animated graphic images; c) text, sound, and video images; d) video and sound; e) multiple display areas, images, or presentations, presented concurrently. Multimedia has found many applications in the fields of advertising, web design, electronic publishing, technical documentation, information and asset management, and education.

Multimedia software is used typically in computers to present text, graphics, video, animation, and sound in an integrated fashion. Multimedia software is typically built of two basic components: a multimedia generator and a multimedia assembler with which multimedia applications are created and accessed.

Recently, electronic mail-based and cellular telephone-based multimedia messaging have became basic communication tools, the use of which has become widespread. Multimedia communication provides the advantage of an enriched medium in which expression, feeling, emotion and mood, as well as content, can be conveyed. Today, electronic mail systems and cellular telephone systems, in which the user is able to create, store, send, forward and attach multimedia messages to regular e-mail messages, are well known and are among the communication tools used by many on a daily basis.

Multimedia messaging is a communications technology that allows users to exchange multimedia communications between capable mobile phones and other devices, such as personal computers, typically over the Internet. Multimedia messaging defines a way to send and receive, almost instantaneously, wireless messages that include images, audio, and video clips, in addition to text. A common current application of multimedia messaging is picture messaging or the use of camera phones to take photos for immediate delivery to a mobile recipient. Other known applications include animations and graphic presentations of stock quotes, sports news, and weather reports.

One problem associated with such mail and cellular systems is that they do not provide for advanced media types, such as, for example, streaming video. Another problem is that the existing systems provide only for multimedia messaging based on pre-prepared and pre-stored non-flexible media forms. The options for choosing one of the media forms and the personalization of the standard forms are fairly limited. Typically, a user desiring to send a multimedia message is given the option to select a pre-prepared and pre-stored multimedia message from a set of pre-prepared messages that are stored in the system and are arranged by categories and sub-categories. These provide a limited variety in respect of the expression and the moods sought by the user. For example, if the user desires to send a greeting card, he could select one of several categories, such as greeting cards, one of several sub-categories, such as birthday cards, wedding anniversary cards, seasonal greeting cards or the like. Once a certain pre-prepared message is selected by the user, the message can be personalized only in a substantially limited manner, such as, for example, by generating an accompanying text by keying in a text segment to be inserted in a pre-determined format into a pre-determined space in the body of the message.

PCT publication WO07/083,294, to the present applicant, discloses an apparatus for the creation and transmission of personalized multimedia messages. The apparatus includes a multimedia message assembler in a Personal Computer (PC), for creating a multimedia message by assembling and manipulating diverse media type content segments, a shared creative content database, to store diverse media type content segments and to provide the diverse media type content segments to the multimedia message assembler in response to a request; and a multimedia message forwarding mediator to receive multimedia messages and receivers' addresses associated therewith, to communicate with a recipient device, to reformat the multimedia message according to the multimedia capabilities of the recipient device, and to forward the multimedia message to the recipient device. This apparatus permits enhanced and advanced personalization of the messages, such as enabling the selection of the visual elements, such as introducing one or more still images, enabling the addition of desired audio elements, such as specific songs including vocals and/or instrumental music, enabling the selection and insertion of specific text in a variety of formats and locations, enabling the addition of personally recorded or personally captured media types, and the like.

A second aspect of the PCT publication regards a method for the creation and transmission of unique personalized multimedia messages from a sending device to a recipient device. The method includes obtaining media type content segments from a shared creative content database, creating a multimedia message by assembling and manipulating the diverse media type content segments, and forwarding the multimedia message to the recipient device.

However, the system of this PCT publication doesn't enable creating a multimedia message on a cellular phone, since the system requires a large size memory and powerful processing capabilities. In addition, this system only allows retrieval or later editing of a multimedia message on the computer on which the multimedia message was originally created.

Accordingly, there is a long felt need for a system for composing and sending a personalized multimedia message by means of a cellular phone, and it would be very desirable to have a system permitting viewing and editing of a multimedia message by devices other than that on which the multimedia message was originally created.

### SUMMARY OF THE INVENTION

There is provided according to the present invention a sending device for use in a system for sending multimedia messages, the sending device comprising a computing device with communications capabilities, a multimedia message composer in the computing device, and a processor including the multimedia message composer for creating and storing an instruction file. The instructions file includes addresses of at least one media-type content input stored on a remote server device and/or data from the computing device, which, when assembled in the remote server device, create the multimedia message.

According to a preferred embodiment of the invention, the sending device further comprises a memory for storing the instruction file.

There is also provided according to the present invention a system for sending multimedia messages comprising a messaging server which includes a storage unit and a processing unit having a multimedia message assembler for assembling a multimedia message from at least one media-type content input stored in the storage unit by executing an instruction file. The system further includes at least one sending device, coupled for telecommunication to the server device.

There is also provided in accordance with the present invention a method for sending multimedia messages, the method comprising creating an instruction file including addresses of at least one media-type content input stored on a remote server device and/or data from said sending device, by in a sending device, having a computing device with communications capabilities. The method further includes the steps of selecting at least one media-type content input stored on a remote server device, and adding an address of the media-type content input in the remote server device to said instruction file. The instruction file is utilized by the remote server device for assembling the multimedia message.

### BRIEF DESCRIPTION OF THE DRAWINGS

The present invention will be further understood and appreciated from the following detailed description taken in conjunction with the drawings in which:

FIG. 1 is a schematic block diagram of a messaging system constructed and operative in accordance with one embodiment of the present invention;

FIG. 2 is a schematic block diagram of a sending device, constructed and operative in accordance with one embodiment of the present invention, for a messaging system;

FIG. 3 is a schematic block diagram of a messaging system constructed and operative in accordance with one embodiment of the present invention;

FIG. 4 is a schematic block diagram of a messaging system constructed and operative in accordance with another embodiment of the present invention; and

FIG. 5 is a flow chart illustrating operation of a messaging system, according to one embodiment of the invention.

FIG. 6 is a schematic illustration of a main display of a multi media assembler, according to one embodiment of the invention.

### DETAILED DESCRIPTION OF THE INVENTION

The present invention relates to a system and method for creating and sending, by means of a telecommunications device, such as a cellular telephone, unique, dynamically personalized multimedia messages to a remote recipient, including generating, capturing, selecting, recording, and assembling media-type content inputs by means of the telecommunications device, and transmitting the personalized multimedia message for access and display to a remote recipient operating a multimedia access and display device. For purposes of the present invention, all video, audio, voice, text or graphic elements, in any form, to be utilized in the multimedia message, will be denoted by the term “media-type content inputs”.

This is made possible by creating an instruction file for remotely assembling a multimedia message, rather than merely storing a complete multimedia message. The use of instruction files permits telecommunication device users to compose complex multimedia messages without requiring storage in the device's limited memory, and later manipulation of the multimedia message by the user himself or a person with sharing access, by changing one or more of the instructions related to a media-type content input, thereby creating a new version of the multimedia message without having to go through the entire process of composing a new message.

The personalized multimedia message may include video, audio, text and/or graphics. The system includes a server for storing multimedia elements for composing the message and each user's personalized composition, which forms a unique multimedia message. The server enables accessing and editing of the message from a remote PC or a cellular phone or any other device having computing and telecommunication capabilities. The system utilizes a communication network allowing PCs and cellular phones to access the multimedia elements and the multimedia message. The communication network may be part of an existing cellular network and/or the Internet.

According to a preferred embodiment of the invention, the multimedia message is assembled and stored as an array of addresses of the multimedia elements on the server. The addresses permit a complex message to be assembled and stored without requiring a large memory in a sending cell phone or other mobile device and allow manipulation of the message with ease. It is a particular feature of the invention that multimedia messages can be created by means of any computing device having telecommunications capabilities, including PDA's, cellular phones, personal computers, etc., without requiring or using a large memory or strong processing capabilities in the sending device, and utilizing a relatively narrow bandwidth.

In some preferred embodiments of the present invention, the content of the multimedia message is a unique, dynamically personalized greeting message. The greeting message is a social expression that includes the sending of salutations, regards, respects, remembrance, felicitations, well-wishing, compliments, or best wishes from one individual and delivered to one or more other individuals. In other preferred embodiments of the invention, the content and the purpose of the multimedia message could be different, such as unique targeted advertising content for commercial purposes, unique personalized musical/audio clips or gaming content for professional or amateur entertainment purposes, and the like. In the preferred embodiments of the present invention, the multimedia message is created from multiple media-type content inputs having diverse formats within digitally stored libraries. The media-type content inputs may include stored video, stored audio, stored still images, stored still image sequences, stored text, and stored karaoke, and so on. The media-type inputs are digitally stored in specific libraries on the server or could be captured from various magnetic media or optical media, such as magnetic disks or DVDs, or uploaded from cellular phones, computers and other communication devices. Thus, media-type content inputs could be captured from recording devices coupled to the composing device, such as a camera, camcorder, a microphone, a keyboard, and the like. In other preferred embodiments, the media-type contents could further include animation segments, icons, graphics, either digitally stored in specific media-type content libraries or captured from various media sources, such as downloading from a data communications network, and the like.

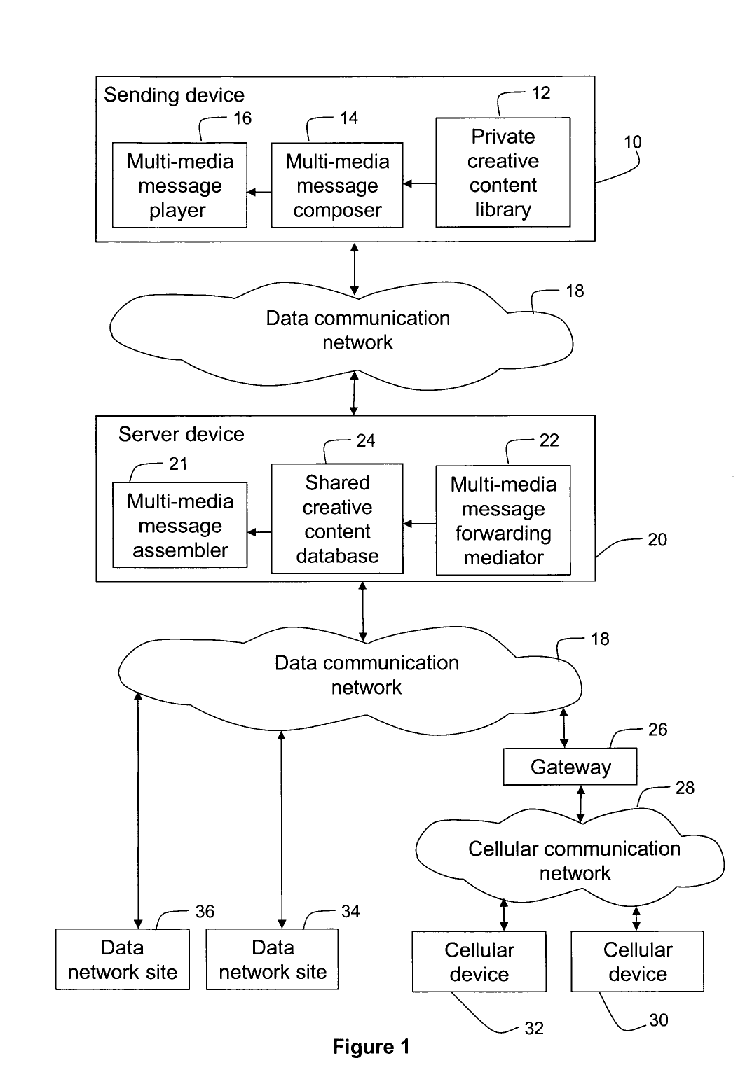

Referring now to FIG. 1, there is shown a schematic illustration of a messaging system 1, in accordance with a first preferred embodiment of the present invention. Messaging system 1 includes a sending device 10, and a server device 20. The sending device 10 is used by the sender to create a multimedia message by creating a instruction file, including addresses of various media-type content inputs stored on server device 20, text and/or pictures which, when assembled in server device 20, comprise the multimedia message. Sending device 10 is a computing device with communications capabilities. According to one embodiment, sending device 10 is a cellular phone or other mobile computing device having limited computing capabilities, and according to another embodiment sending device 10 is a personal computer. Sending device 10 is communicatively linked to a data communication network 18, such as the Internet and/or a cellular telecommunication network.

Sending device 10 includes a multimedia message composer 14. Message composer 14 permits a user to compose his unique dynamically personalized multimedia message by previewing and selecting particular media-type content inputs located on server 20, when prompted by the message composer 14. Device 10 further includes a multimedia message player 16, to preview portions of the media-type content inputs and the multimedia message in progress, and a private creative content library 12 to store temporarily downloaded, captured and recorded media-type content inputs.

Multimedia message composer 14 is a set of inter-related software programs the functionality of which is to collect the addresses of each of the media-type content inputs located on server 20, and to assemble them into a unique instruction file to be sent to server 20. Multimedia message player 16 is a set of logically inter-related software programs the functionality of which is to allow playing of at least a portion of each media-type content input and to play the unique multimedia message once server 20 has assembled the message based on the instruction file sent from composing device 10. Private creative content library 12 is a database stored on a memory device (not shown) of sending device 10. Library 12 may store media-type content inputs which are not stored on the server, such as personal pictures, taken by the user, or media-type content inputs from an external source, such as a web site or any other source of data. The address of a desired recipient and preferred transmission scheduling parameters are appended to the instruction file, and the file is transmitted via diverse communication software, hardware and lines to server 20 via data communications network 18.

Server 20 is a computing device, the functionality of which is: a) to provide a list of requested media-type content inputs to sending device 10, via data communication network 18, b) to provide a preview of requested media-type content inputs to sending device 10, c) to receive the instruction file from sending device 10, d) to assemble the multimedia message in accordance with the instruction file, and e) to transmit the multimedia message to one or more recipient devices 30, 32, 34, 36 via data communications network 18 or via an inter-network gateway device 26 and, consequently, to a cellular communications network 28. The recipient devices 30, 32 are linked to cellular communications network 28 and, are illustrated here as cellular communications devices, such as cellular telephones. The recipient devices 34 and 36 are linked communicatively to data communications network 18. Devices 34 and 36 are computing devices with communication capabilities and with multimedia content playing capabilities, such as a PC connected to the Internet. Multimedia messages received by recipient devices 30, 32, 34 and 36 are replayed by the user of the devices in a format suitable for that particular recipient device, in order to perceive the content of the message.

Server device 20 includes a shared creative content database 24 and a multimedia message forwarding mediator 22. Database 24 is a data structure for storing media files. In response to requests of the user of sending device 10, a list of specific media-type content inputs are transmitted to sending device 10 in order to inform the user of device 10 of the media-type content inputs available on the server for the creation of the multimedia message. The list of media files is preferably divided to types, such as pictures, video files, and audio files. The list may further be divided to different categories, such as love expressions, thanks, birthday wishes, etc. In addition, the list may be accompanied by a thumbnail or other sample, for preview purposes.

Server device 20 further includes a multimedia message assembler 21, which is a software program for receiving the instruction file from sending device 10 and assembling the final multimedia message. Server device 20 also includes a multimedia message forwarding mediator 22, a software program for communicating with the recipient devices, responding to the capabilities of the recipient devices, formatting the messages in accordance with the characteristics of the recipient devices, sending the message to the recipient devices, and the handling of the sent multimedia messages. Server 20 is further responsible for generating and transmitting error messages or other feedback messages to sending device 10, concerning the results of the message delivery process.

Still referring to FIG. 1, note should be taken that although, on the drawing under discussion, only a single sending device, a single server device and a few recipient devices are shown, in a realistic environment a plurality of sending devices could create a plurality of multimedia output messages and transmit the messages to a plurality of recipient devices via one or more server devices. Further note should be taken that in other preferred embodiments of the present invention, diverse other communications networks could be used, such as a local area network, a satellite communication network, a landline telephone network, a cable communications network or combinations thereof. It will be appreciated by one with ordinary skill in the art that, subject to the installed software, sending device 10 is capable of functioning as a recipient device or a sender/recipient, while recipient devices 30, 32, 34, 36, subject to the installed software, could function as sending devices or recipient/sender devices.

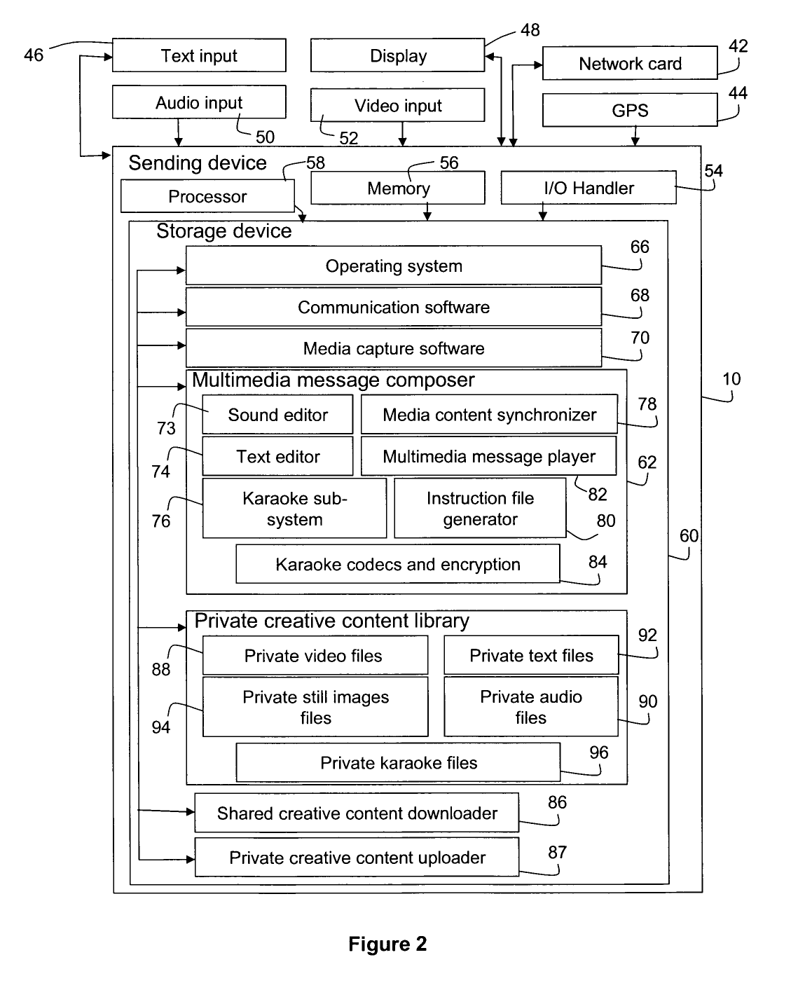

Referring now to FIG. 2, in one preferred embodiment of the invention, sending device 10 is a computing device, such as a cellular phone or personal computer, having communications capabilities. Sending device 10 includes a processor device 58, a memory device 56, such as a RAM, a ROM, a PROM, or an EPROM, and a storage device 60, such as a flash memory. Several peripheral devices may be built in or attached to sending device 10. The peripheral devices may include a text input device 46, such as a keyboard, a mouse, a display device 48, such as an LCD screen or a plasma screen, a network interface card 42, an audio input device 50, such as a microphone, a video input device 52, such as a camcorder or a Web camera, for recording video images, still photos and audio onto storage device 60.

Processor 58 is the logic circuitry that responds to and processes the basic instructions that drive a computer. Processor 58, when installed in a personal computer or embedded in mobile devices, is typically a microprocessor. Memory 56 is the electronic holding place for instructions and data that the computer's processor can reach quickly. Memory 56 is distinguished from storage device 60 that holds the much larger amounts of data that would not fit into RAM and may not be immediately needed there. Storage devices include any electronic memory storage device, such as hard disks, magnetic disks, optical disks, floppy disks, CD-ROM, and tape backup systems. Preferably, sender device 10 further includes GPS capabilities 44, which may be used for locating sending device 10. Once the location of sending device 10 is determined, the user may be prompted, as by the message composer, to incorporate in the multimedia message media-type content inputs which are related to his location, for example a picture of a tourist site, a video clip of a museum, etc.

Still referring to FIG. 2, storage device 60 includes an operating system 66, communications software 68, media capture software 70, a multimedia message composer 62, a private creative content library 64, a private creative content uploader module 87, and preferably, a shared creative content downloader module 86. Operating system 66 is the system software responsible for the direct control and management of hardware and basic system operations and it provides a foundation upon which to run application software, such as a personal phonebook, web browsers and others. Media capture software 70 is logically coupled to peripheral devices and is responsible for capturing media-type content input from all the suitable sources, such as the Internet, private library, recording input devices, etc. Communications software 68 is responsible for the performance of communications in association with the network interface card 42.

Multimedia message composer 62 is the primary client-side software. The functionality of composer 62 is to provide the user with the option of selecting and previewing media-type content inputs, creating and transmitting a multimedia instruction file. Composer 62 is capable of responding to the user's requests regarding: a) adding media-type content inputs, b) editing, mixing, combining, manipulating, joining, replacing, separating media-type content inputs, so as to create an output instruction file, c) obtaining transmission parameters, such as date of transmission, recipient address, and the like, d) storing the output instruction file, e) capturing and recording media-type content inputs, and f) sending captured media-type content inputs for storage in a shared remote database or a local library for later use. Multimedia message composer 62 is a set of logically inter-related software programs. According to one embodiment, once the user chooses the media-type content inputs he wishes to incorporate in the multimedia message, and the unique combination of these inputs, the server assembles the multimedia message accordingly. Composer 62 includes a text editor module 74, for manipulating text segments, a sound editor module 73, for manipulating audio segments, and preferably, a karaoke sub-system 76, for recording customized vocals on pre-defined instrumental music segments. In addition, multimedia composer 62 may include a media-type synchronizer module 78, to synchronize audio input, video input, text input, animation input and recorded input. Multimedia composer 62 further includes an instruction file generator module 80, which generates the instructions file including the combination of selected media-type content inputs to be sent to the server. According to one embodiment of the invention, instruction file generator module 80 composes and sends the instruction file to server 20 of FIG. 1 as an XML message. In this case, the server will include software for retrieving the media-type content inputs based on the XML message. Alternatively, the instruction file may be composed in any other common language recognized by the server.

Multimedia composer 62 further includes a multimedia message player module 82, for previewing the media-type content inputs or the multimedia message prior to sending. Multimedia composer 62 may further include a karaoke coder-decoder and encryption/decryption module 84, for generating novel unique karaoke text/controls file.

Private creative content library 64 stores private media-type content inputs that include private video files 88, private audio files 90, private text files 92, private still image files 94, and private karaoke files 96. Shared creative content downloader module 86 receives requests from the user concerning a media-type content input which is not located on the server or in private library 64. Private creative content uploader module 87 receives requests from the user concerning the transmission of the media-type content input from the private creative content library 64 on the sending device 10 and uploads the media-type content input from the sending device 10 to the shared creative content database 24 on the server device 20, as described below.

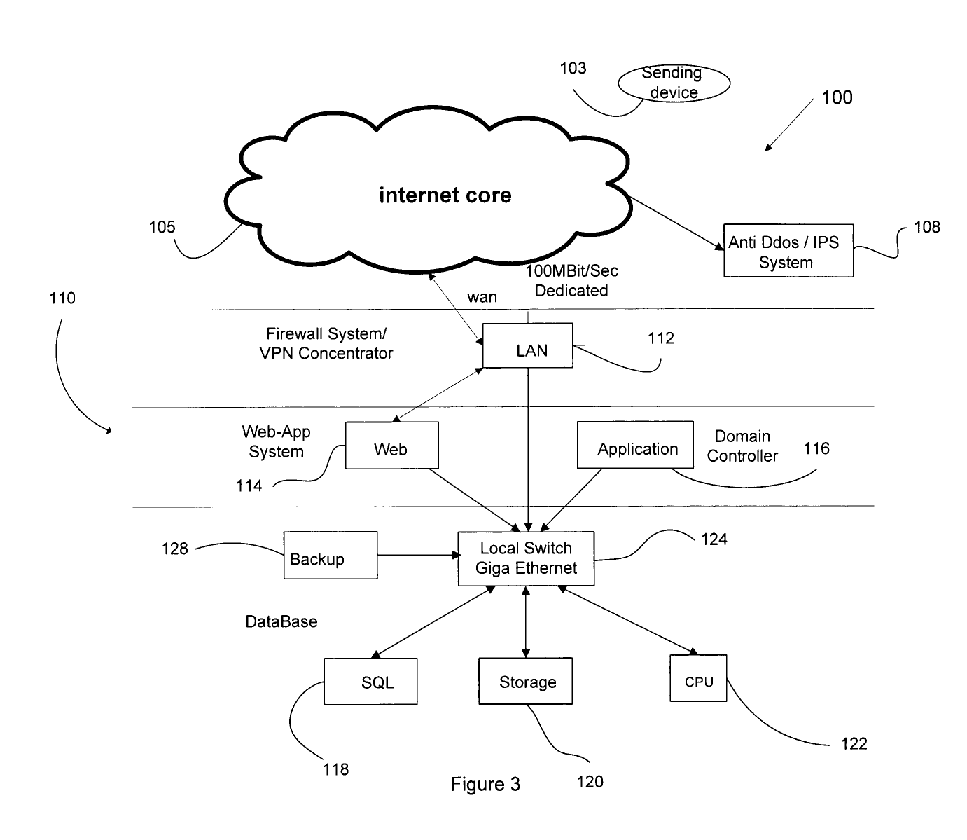

FIG. 3 is a schematic block diagram of a messaging system 100 according to one embodiment of the invention. Messaging system 100 includes a messaging server 110 coupled to a communication network 105, such as Internet, a cellular communication network, etc., and sending/recipient devices 103. Messaging server 110 includes a firewall system 112, which is designed to prevent unauthorized Internet access to messaging server 110. Firewall system 112 defines who is authorized to access messaging server 110 and, depending on the level of authorization, what kind of data they are allowed to use. Messaging server 110 may include, instead or in addition, a Virtual Private Network (VPN) concentrator providing a secured tunnel for remote access.

Messaging server 110 further includes a web server 114, an application server 116, a SQL (Structured Query Language) unit 118, a storage unit 120, and a processing unit 122. The different servers and units on messaging server 110 are coupled to each other via a local switch 124, which manages the data traffic on messaging server 110. Web server 114 serves as the user's gate to messaging server 110, and receives users' requests, such as a list of categories request, a list of media-type content inputs request, a request to assemble a user's composed multimedia message for preview or sending, etc. Application server 116 directs the user's request to SQL unit 118, storage unit 120, and/or a processing unit 122, depending on the type of request. Application server 116 may be divided to different applications, at least one for each communication network, each matching the technical characteristics of the specific network. Web server 114 is configured to identify the characteristics of the communication network to which the requesting user belongs, and directs the user's requests to the appropriate application on application server 116.

Storage unit 120 stores the media-type content inputs and the personal multimedia messages of the various users. Preferably storage unit 120 is divided into a public directory and a private directory. The public directory is designed to hold the videos, audios, pictures and other media-type content inputs provided by the multimedia message service provider. The public directory can be accessed from any sending device and the media-type content inputs on the public directory can be incorporated in any multimedia message. According to one embodiment of the invention, storage unit 120 also stores a small portion of each media-type content input for preview thereof. The private directory is designed to hold a directory for each user, including different versions of his or her multi-media messages, old messages, default messages, personal pictures, videos, and texts. The private directory is divided to sub-directories assigned to each user. Each sub-directory is accessible only by its associated user. Each sub-directory can be accessed by the user from any computer, cell phone, etc., through communications network 105, using the appropriate login. In sharing applications, such as social networks, a portion of the user's private directory can be publicly accessible, whereby the user's contacts can access and edit his multimedia messages. In addition, storage unit 120 holds a temporary directory for uploads, and web interfaces written in different protocols, such as html, xml, etc.

SQL server 118 is based on Structured Query Language, which is a standard interactive and programming language for retrieving and modifying data and querying and managing databases. SQL server 118 manages the media-type content inputs and complete multimedia messages stored in storage unit 120, by means of the unique address of that data in storage unit 120. SQL unit 118 permits a fast search of categories of media-type content inputs, such as birthday wishes, thanks, apologies, etc. In addition, SQL server 118 stores a text associated with each media-type content input, where the text may be a name or a description. In addition, SQL server 118 stores suggested text for incorporating in the multimedia message. SQL unit 118 may further store instruction files for assembling the user's multimedia message, composed by the sending device 103, for later retrieval. As stated above, storing the instruction files allows for later manipulation of the multimedia message by the user himself or a person with sharing access, thereby creating a new version of the multimedia message without having to compose a brand new message.

Processing unit 122 carries out the processes required for assembling and creating the multimedia messages, such as video formatting, picture resealing, text editing, etc. A backup unit 128 is preferably provided for securing the data in storage unit 120. Backup unit 128 is periodically synchronized with the storage unit 120.

Messaging server 110 is accessed through the communication network 105, here illustrated as the Internet (WAN), which enables heavy data traffic. Anti-Ddos technology 108 (Distributed denial-of-service attack) is preferably included in the network. Anti-Ddos 108 prevents attacks which may make the system's resources unavailable to its intended users, for example, by saturating the messaging server 110 with external communications requests, so that it cannot respond to legitimate traffic, or responds so slowly as to be rendered effectively unavailable. Anti-Ddos 108 may be carried out by using Intrusion-prevention systems (IPS), which recognize signatures associated with the Dos attack and block them.

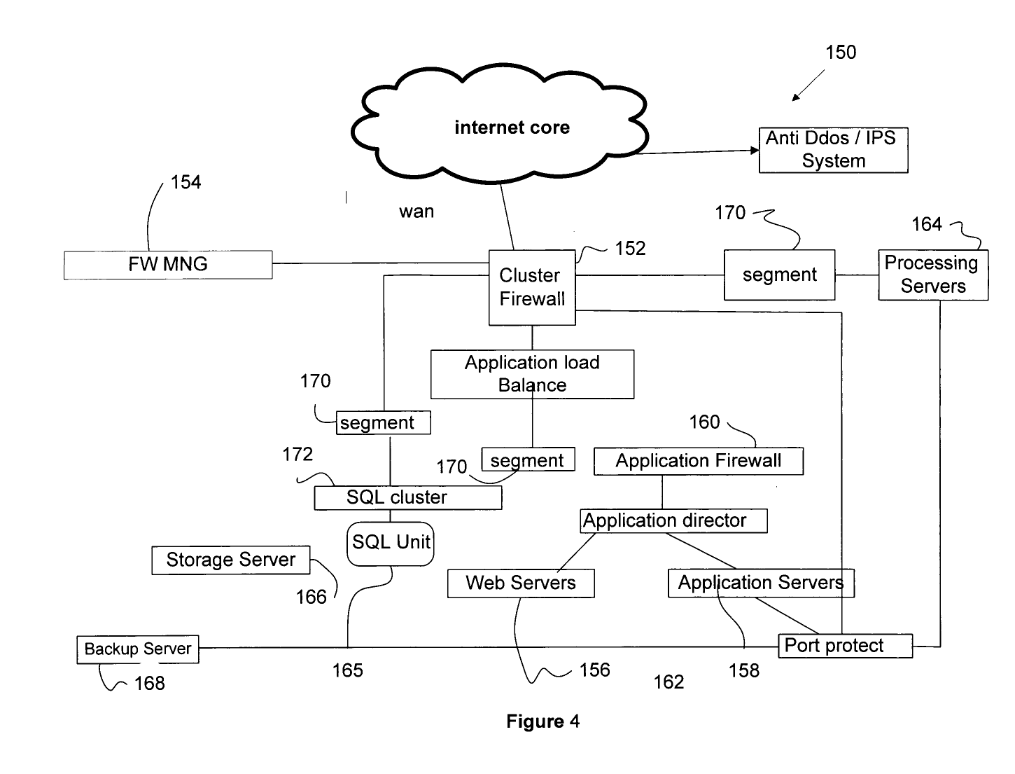

FIG. 4 is a schematic block diagram of a messaging system 150, according to another embodiment of the present invention. According to this embodiment, messaging system 150 can be expanded upon growing demand, and is highly secure. Messaging system 150 includes a cluster firewall 152 having more than one hardware based firewall, each of which serves as a backup, in case of a malfunction of the other one. In order to enhance the security of messaging system 150, cluster firewall 152 is managed only by a dedicated firewall manager 154, so as to prevent manipulation of the settings of the firewall system from a remote location.

According to this embodiment, messaging system 150 further includes one or more web servers 156 for receiving requests from the user, and one or more application servers 158 for directing the requests. In order to further ensure the security of messaging system 150, an application firewall 160 is provided, preventing unauthorized access from web servers 156 to application servers 158. Messaging system 150 further includes an application director 162, which balances the application load by routing the requests to the different application servers 158.

Messaging system 150, according to this embodiment, further includes one or more processing servers 164, one or more SQL units 165, a storage server 166, and a backup server 168. In order to improve the data traffic in messaging system 150, network segments 170 are preferably installed between the different units of messaging system 150, ensuring a fast data flow. Each segment 170 serves as a local switch. According to this embodiment, messaging system 150 is provided with a SQL cluster 172, enabling the addition of further SQL servers, upon demand.

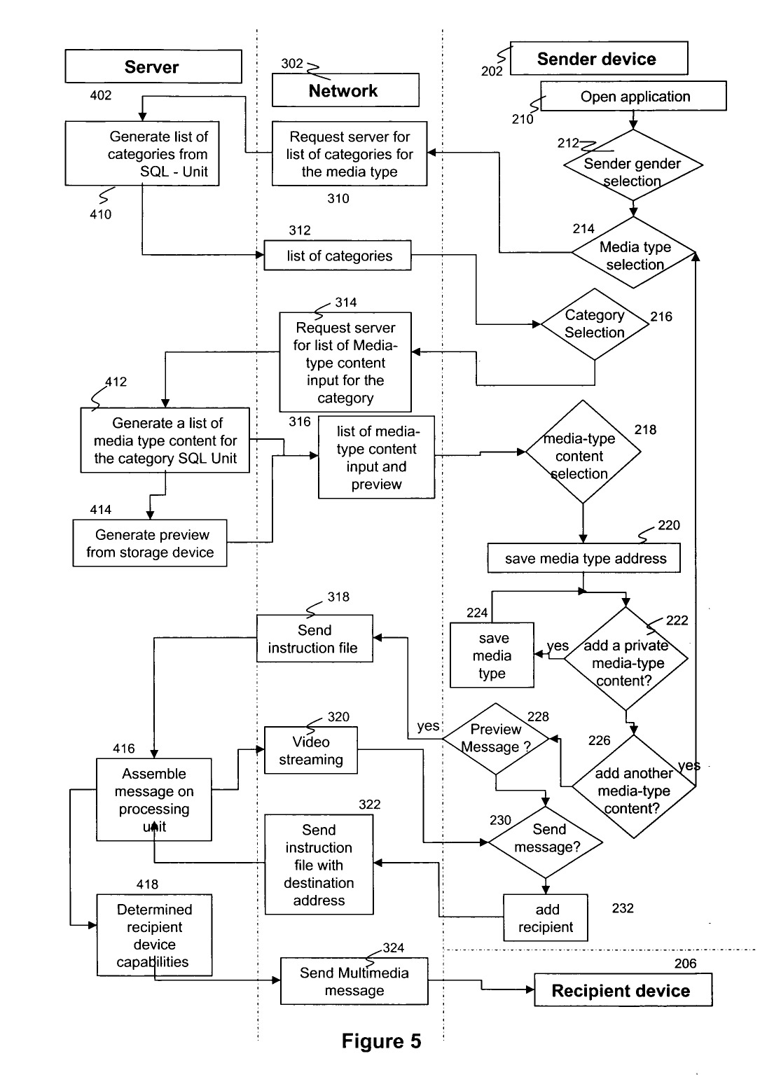

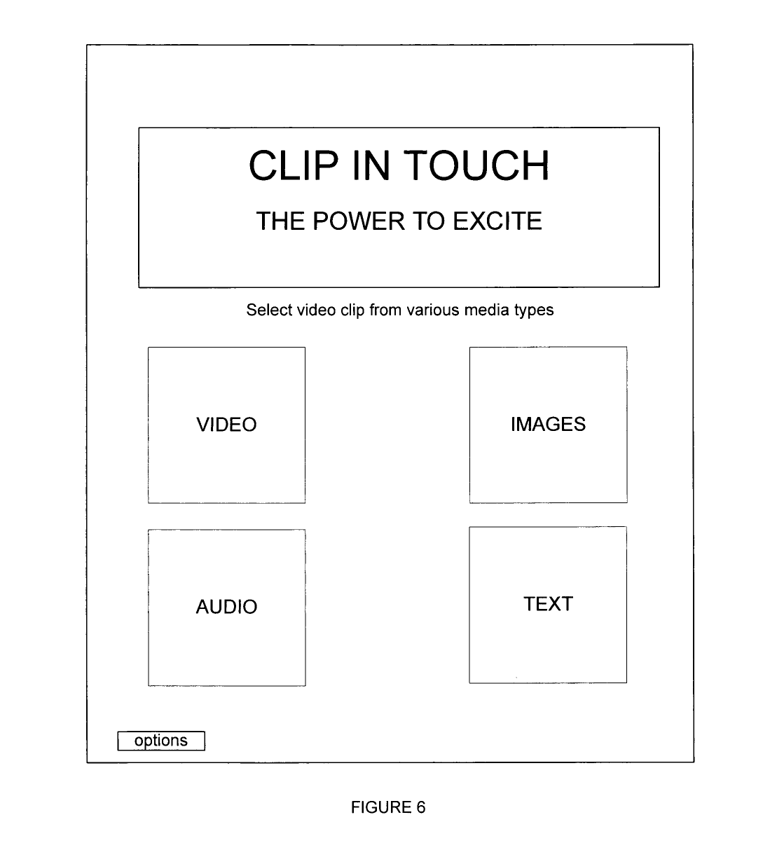

FIG. 5 is a flow chart illustrating a method of composing, assembling and sending a multimedia message, according to a preferred embodiment of the invention. The method, according to this embodiment, is carried out by means of a sending device 202, which is connected for communication to server 402 via a communication network 302. Multimedia message composer software 210 is installed in sending device 202. When the user wishes to compose a multimedia message, multimedia message composer software 210 preferably prompts the user to select his or her gender (block 212), so as to allow server 402 to suggest media-type content input in accordance with the sender's gender. For example, a male sender is suggested to send love expression clips appropriate for a female recipient, or to incorporate text which is grammatically conjugated for a male sender. The user is further prompted to choose the media type (block 214) he chooses to incorporate in the message. The media-type, in this example, refers to video content, audio content, text or images. Preferably, prompting to select the media-type is carried out using icons displayed on the sender device 202, such as can be seen on FIG. 6.

Still referring to FIG. 5, once the user selects the media type (block 214), the multimedia message composer in sending device 202 sends server 402 a request for a list of categories 310 via network 302. The categories referred to are categories of content, such as thanks, birthday wishes, apologies, love expressions, etc. Each media-type content input stored in the storage unit on server 402 is assigned one or more categories. Dividing the media-type content input to categories facilitates the search, and eliminates the necessity of going through a long list of media-type content input which are not relevant to the user. Category request (block 310) is first received by the web server in server 402, which directs the request to the appropriate application in the application server, in accordance with the network characteristics of the network of sending device 202. The application server directs category request (block 310) to the SQL server in server 402. In the SQL server, a list of media-type content inputs divided to media types is stored, together with the categories of each media type, and preferably, sub categories. The SQL server generates the category list (block 410) requested from a specific media type, and sends the category list (block 312) via network 302 to sending device 202.

The user is then prompted to select the desired category (block 216). Once the user has chosen the category, the multimedia message composer sends server 402 a request for a media-type content input list (block 314) from that category, via network 302. The request is directed to the application server in server 402 through the web servers. The application server retrieves from the SQL unit a list of all the media-type content input (block 412) related to the category selected by the user (block 216). The application server sends the media type content input list (block 316) to sending device 202 via the web server and network 302. In case the media-type content input includes a preview, such as a short preview video or a preview image, the application server retrieves the preview files from the storage unit, and sends the preview files to the sending device by means of web application and network 302. Alternatively, the application server may permit playing of a portion of the media-type content inputs, themselves, as a preview.

The user is now prompted to select a desired media-type content input from the list (block 218). Once user selects the desired media-type content input, the multimedia message composer saves the storage address of the selected content (block 220) in a dedicated instruction file. The address may be a number or other identification code, which is recognized by server 402, for retrieving the desired content from the storage unit when the actual message is assembled. The user may now be prompted to select a media-type content input from a personal library (block 222) which is stored on sending device 202 or other location (which is not server 402). If the user chooses to add a media-type content input which is not stored on server 402, the data representing the selected content is saved in the instructions file (block 224) on sending device 202. The user is now prompted (block 226) to select another media-type content input to be added to the multimedia message. If he wishes to do so, he returns to media type selection (block 214).

Once one or more media-type input was selected, the user may choose to preview the multimedia message (block 228) as composed so far. If the users opts to preview the multimedia message, sending device 202 sends a preview request (block 318), along with the instruction file including the storage addresses of the selected media type content inputs and the data representing the media-type content which is not stored on server 402. The instruction file is sent to server 402 via network 302, and is directed to the web server in server 402 and then to the appropriate application in the application device. The application device retrieves from the storage unit the media-type content inputs specified in the instruction file and instructs the processing unit to assemble the selected media-type inputs retrieved from the storage unit or sent with the instructions file, so as to create the multimedia message (block 416). The multimedia message is sent to sending device 202, preferably as video streaming (block 320). Preferably, the multimedia message preview is stored in the user's private directory on server 402.

The user may then choose to send the message (block 230) to one or more recipients. Alternatively, the user may choose to save the instruction file on server 402 for later editing and/or sending. If the user decides to send the message, he is prompted to select a recipient address (block 232), which may be a telephone number, email address or any other recipient address which is recognized by a service provider of the recipient and which is accessible by communication network 302. According to a preferred embodiment of the invention, the multimedia message composer is preferably synchronized with a personal information manager (not shown) having a list of user's contacts and their recipient addresses. The personal information manager may be an email program, such as Microsoft Outlook, Outlook Express or any other email service provider, such as Gmail, Yahoo, etc. In case synchronization of contact addresses is not possible, for example, when the cellular phone does not include a personal information manager or the desired contacts are not stored on the cellular phone, the user may import the contact's information from any other source of information, such as MSN, AOL, Yahoo or a database on his personal computer, such as Microsoft Outlook, etc.

After the user selects a recipient address, the instruction file including the recipient address is sent to server 402. The application server on server 402 handles the sending request by assembling and creating the multimedia message. In case a message preview was requested previously, the application server can merely retrieve the previewed message. Preferably, the multimedia message is saved in different formats so as to allow sending of the message to recipient devices having different technical capabilities. Preferably, one of the formats is a 3GP format, which is a simplified version of the MPEG-4 Part 14 (MP4) container format, designed to decrease storage and bandwidth requirements in order to accommodate mobile phones. 3GP enables forward blocking by defining the recipient's device as the only authorized viewer of the content in the message. At present, the message can be sent to the recipient device by WAP push or MMS. MMS delivery may be carried out by sending a short notice to the recipient device 206 and requesting feedback which includes the software information and communication technology supported by the device. In case the recipient device does not support MMS, the server may send the message via WAP push technology, which is based on a link sent to the recipient's device, whereby the recipient may play the message off the server as a streaming multimedia or may choose to download the entire message to his or her phone.

For WAP push, in order to determine the capabilities of the recipient device, server 402 sends the recipient device a short message (SMS) prompting the recipient to receive a multimedia message. If the recipient confirms reception of the message, the required information regarding the software and capabilities of recipient device 206 is sent automatically to server 402 and is used by the server to select the appropriate format for the multimedia message.

In the case of MMS, a signal is sent to the recipient device 206 and, in response, recipient device 206 automatically sends the required information regarding the software and capabilities of recipient device 206 to server 402. In response thereto, the application server in server 402 sends the appropriate format of multimedia message as an MMS.

It will be appreciated that, in the embodiment described above, the multimedia message composing process is a serial process. That is, the message composer prompts the user to add or select content in a specific, pre-defined order. In this case, the user must scroll through and reject each category in which he or she is not interested.

According to a preferred embodiment of the invention, the multimedia message composing process is a star editing process. According to this method, each content type/category can be selected at will by the user, in any desired order, and only those categories the user chooses to use will be presented to him. Thus, selecting a different media-type content input, for example, may be carried out at any point by referring to the main display, such as shown on FIG. 6, having icons representing different media types.

According to yet another embodiment of the invention, the composing process can be accomplished in a plurality of windows, which can be open at the same time, which permit selection from any category and content type, as via drag and drop, that is desired by the user.

It will be appreciated that the server can sit on the Internet, in which case the assembly of the multimedia message is accomplished on the server and the communication network is the Internet. Alternatively, the server can sit in a telecommunications service provider, whereby the message can be composed and sent via the service provider communication network, and not via the Internet.

In order to allow broader and more efficient service, the messaging system may be connected to the cellular provider application, which may provide content management, statistics of the user and the user's preferred settings.

According to another embodiment of the invention, advertisements can be attached to the multimedia message before sending. The advertisement may be an opening clip matched to the specific recipient, in accordance with his personal profile, as derived from the cellular phone provider's database. In a preferred embodiment, the user sending the multimedia message may choose to pay for sending the multimedia message or, alternatively, to fully or partially avoid payments by agreeing that an advertisement be attached to the multimedia message he wishes to send.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A sending device for use in a system for sending multimedia messages, the sending device comprising:
a computing device with communications capabilities; and
a multimedia message composer in said computing device;
a processor including said multimedia message composer for creating and storing an instruction file including addresses of at least one media-type content input stored on a remote server device, which, when assembled in said remote server device, create the multimedia message.

2. The device according to claim 1, further comprising a memory for storing said instruction file.

3. A system for sending multimedia messages comprising:
a messaging server including:
a storage unit; and
a processing unit including a multimedia message assembler for assembling a multimedia message from at least one media-type content input stored in said storage unit by executing an instruction file; and
at least one sending device, coupled for telecommunication to said server device, said sending device including:
a computing device with communications capabilities; and
a processor including a multimedia message composer for creating and storing said instruction file including addresses of various media-type content inputs stored in said storage unit on said server device.

4. A method for sending multimedia messages, the method comprising:
in a sending device, having a computing device with communications capabilities, creating an instruction file including addresses of at least one media-type content input stored on a remote server device by:
selecting at least one media-type content input stored on a remote server device; and
adding an address of said media-type content input in said remote server device to said instruction file;
wherein said instruction file is utilized by said remote server device for assembling the multimedia message.

5. The method according to claim 4, further comprising assembling said multimedia message in said remote server.

6. The method according to claim 4, further comprising previewing said assembled multimedia message.

7. The method according to claim 4, further comprising sending said multimedia message to at least one recipient device.

8. The method according to claim 7, further comprising:
providing an address of at least one recipient device to said server device; and adapting said message to characteristics of said recipient device;
before said step of sending.

9. The method according to claim 4, further comprising storing said instruction file in said remote server.

10. The sending device according to claim 1, wherein said instruction file further includes data from said computing device.

11. The system according to claim 3, wherein said instruction file further includes data from said computing device.

12. The method according to claim 4, wherein said step of creating an instruction file further includes creating an instruction file including data from said sending device.

13. The method according to claim 5, further comprising storing said instruction file in said remote server.

14. The method according to claim 5, further comprising previewing said assembled multimedia message.

15. The method according to claim 5, further comprising sending said multimedia message to at least one recipient device.

16. The method according to claim 6, further comprising sending said multimedia message to at least one recipient device.
